(19) United States
(12) Patent Application Publication
(10) Pub. No.: US 2007/0038697 A1
(43) Pub. Date: Feb. 15, 2007

(54) Multi-protocol namespace server

(76) Inventors: Eyal Zimran, London (GB); Christopher H. Stacey, Wiltshire (GB); Stephen A. Fridella, Newton, MA (US); Sorin Faibish, Newton, MA (US)

Correspondence Address: RICHARD AUCHTERLONIE;NOVAK DRUCE & QUIGG, LLP, 1000 LOUISIANA, 53RD FLOOR, HOUSTON, TX, 77002, US

(21) Appl. No.: 11/195,946

(22) Filed: Aug. 3, 2005

(51) Int. Cl. G06F 15/16

(52) U.S. Cl. 709/203

(57) ABSTRACT

A namespace server translates client requests for access to files referenced by pathnames in a client-server namespace into requests for access to files referenced by pathnames in a backend NAS network namespace. The namespace server also translates between different file access protocols. The namespace server may change the translation of a client-server network pathname from an old backend NAS network pathname to a new backend NAS network pathname for file migration without disruption to client access during file migration for load balancing or for a more appropriate service level. Client access can also be routed automatically and transparently to replicas in case of server or site failures. The namespace server may create the appearance of a virtual file system that contains multiple physical servers, a virtual share that contains physical shares from different servers, directories that contain files on different servers, and files that contain data from files on different servers.

### FIELD OF THE INVENTION

The present invention relates generally to data storage systems, and more particularly to network file servers.

### BACKGROUND OF THE INVENTION

In a data network it is conventional for a network server containing disk storage to service storage access requests from multiple network clients. The storage access requests, for example, are serviced in accordance with a network file access protocol such as the Network File System (NFS), the Common Internet File System (CIFS) protocol, the Hypertext Transfer Protocol (HTTP), or the File Transfer Protocol (FTP). NFS is described in Bill Nowicki, “NFS: Network File System Protocol Specification,” Network Working Group, Request for Comments: 1094, Sun Microsystems, Inc., Mountain View, Calif., March 1989. CIFS is described in Paul L. Leach and Dilip C. Naik, “A Common Internet File System,” Microsoft Corporation, Redmond, Wash., Dec. 19, 1997. HTTP is described in R. Fielding et al., “Hypertext Transfer Protocol —HTTP/1.1,” Request for Comments: 2068, Network Working Group, Digital Equipment Corp., Maynard, Mass., January 1997. FTP is described in J. Postel & J. Reynolds, “FILE TRANSFER PROTOCOL (FTP),” Network Working Group, Request for Comments: 959, ISI, Marina del Rey, Calif., October 1985.

A network file server typically includes a digital computer for servicing storage access requests in accordance with at least one network file access protocol, and an array of disk drives. The computer has been called by various names, such as a storage controller, a data mover, or a file server. The computer typically performs client authentication, enforces client access rights to particular storage volumes, directories, or files, and maps directory and file names to allocated logical blocks of storage.

System administrators have been faced with an increasing problem of integrating multiple storage servers of different types into the same data storage network. In the past, it was often possible for the system administrator to avoid this problem by migrating data from a number of small servers into one new large server. The small servers were removed from the network. Then the storage for the data was managed effectively using storage management tools for managing the storage in the one new large server.

When system administrators integrate multiple storage servers of different types into the same data storage network, they must deal with problems of allocating the data to be stored among the various servers based on the respective storage capacities and data access bandwidths of the various servers. This should be done in such as way as to minimize any disruption to data access by client applications. To address these problems, storage management tools are being offered for allocation and migration of the data to be stored among various servers to enforce storage management policies. These tools often have limitations when the various servers use different high-level storage access protocols or are manufactured by different storage vendors. In addition, when files are migrated between servers in order to add or remove a server, it may be necessary for the system administrator to access network clients to re-map a server share from a server that is removed or to a server that is added.

### SUMMARY OF THE INVENTION

In accordance with one aspect, the invention provides a namespace server including memory for storing translation information for translating client requests for access to files referenced by pathnames in a client-server network namespace into requests for access to files referenced by pathnames in a network-attached storage (NAS) network namespace. The namespace server also includes at least one processor coupled to the memory for accessing the translation information. The at least one processor is programmed for translating the client requests for access to the files referenced by the pathnames in the client-server network namespace into the requests for access to the files referenced by the pathnames in the NAS network namespace. The at least one processor is also programmed for changing the translation of a client-server network pathname for a file from an old NAS network pathname for the file to a new NAS network pathname for the file for migrating the file without disruption to concurrent client read-write access to the file.

In accordance with another aspect, the invention provides a namespace server including memory for storing translation information for translating client requests for access to files referenced by pathnames in a client-server network namespace into requests for access to files referenced by pathnames in a network-attached storage (NAS) network namespace. The namespace server also includes at least one processor coupled to the memory for accessing the translation information. The at least one processor is programmed for translating the client requests for access to the files referenced by the pathnames in the client-server network namespace into the requests for access to the files referenced by the pathnames in the NAS network namespace. The at least one processor is also programmed for receiving from a client the client requests for access to files referenced by pathnames in the client-server network namespace in accordance with a first high-level file access protocol, and the at least one processor is also programmed for transmitting to a file server the requests for access to files referenced by pathnames in the NAS network namespace in accordance with a second high-level file access protocol. One of the first and second high level file access protocols is the Network File System (NFS) protocol, and the other of the first and second file access protocols is the Common Internet File System (CIFS) protocol.

In accordance with still another aspect, the invention provides a namespace server including memory for storing translation information for translating client requests for access to files referenced by pathnames in a client-server network namespace into requests for access to files referenced by pathnames in a network-attached storage (NAS) network namespace. The namespace server also includes at least one processor coupled to the memory for accessing the translation information. The at least one processor is programmed for translating the client requests for access to the files referenced by the pathnames in the client-server network namespace into the requests for access to the files referenced by the pathnames in the NAS network namespace. The memory contains a namespace tree defining a translation of the client-server network namespace into the NAS network namespace. The namespace tree includes inodes for names in the client-server network namespace for file server shares, directories, and files.

### BRIEF DESCRIPTION OF THE DRAWINGS

Additional features and advantages of the invention will be described below with reference to the drawings, in which:

FIG. 1 is a block diagram of a conventional data network including a number of clients and file servers;

FIG. 2 is a view of the network storage seen by an NFS client in the client-server network of FIG. 1;

FIG. 3 is a view of the network storage seen by a CIFS client in the client-server network of FIG. 1;

FIG. 4 is a block diagram of a data processing system including the clients and servers from FIG. 1 and further including a policy engine server and a namespace server in accordance with the invention;

FIG. 5 shows a namespace of the file servers and shares in the backend NAS network in the system of FIG. 4;

FIG. 6 shows a namespace tree of the file servers and shares as seen by the clients in the client-server network of FIG. 4;

FIG. 7 is a block diagram of programming and data structures in the namespace server;

FIG. 8 shows the namespace tree of FIG. 5 configured in the namespace server of FIG. 7 as a hierarchical data structure of online inodes and offline leaf inodes;

FIG. 9 shows another way of configuring the namespace tree of FIG. 5 in the namespace server as a hierarchical data structure of online inodes and offline leaf inodes, in which some of the entries in the online inodes represent shares incorporated by reference from indicated file servers that are hidden from the client-visible namespace tree;

FIG. 10 shows another example of a namespace tree as seen by clients, in which the shares of three file servers appear to reside in a single virtual file system;

FIG. 11 shows a way of configuring the namespace tree of FIG. 10 in the namespace server as a hierarchical data structure of online and offline inodes;

FIG. 12 shows yet another example of a namespace tree as seen by clients, in which a directory includes files that reside in different file servers, and in which one of the files spans two of the file servers;

FIG. 13 shows a way of programming the namespace tree of FIG. 12 into the namespace server as a hierarchical data structure of online and offline inodes;

FIG. 14 shows a dynamic extension of a namespace tree resulting from access of a directory in a share and during access of a file in the directory;

FIG. 15 shows a reconfiguration of the namespace tree of FIG. 14 resulting from migration of the directory from one file server to another;

FIGS. 16 to 18 together comprise a flowchart of programming for the namespace server of FIG. 7;

FIG. 19 is a flowchart of a procedure for non-disruptive file migration in the system of FIG. 4;

FIG. 20 shows an offline inode specifying pathnames for synchronously mirrored production copies, asynchronously mirrored backup copies, and point-in-time versions of a file;

FIG. 21 shows a flowchart of programming of the namespace server for read access and write access to synchronously mirrored production copies of a file associated with an offline inode in the namespace tree; and

FIG. 22 shows a dual-redundant cluster of namespace servers.

While the invention is susceptible to various modifications and alternative forms, specific embodiments thereof have been shown in the drawings and will be described in detail. It should be understood, however, that it is not intended to limit the invention to the particular forms shown, but on the contrary, the intention is to cover all modifications, equivalents, and alternatives falling within the scope of the appended claims.

### DETAILED DESCRIPTION OF THE PREFERRED EMBODIMENT

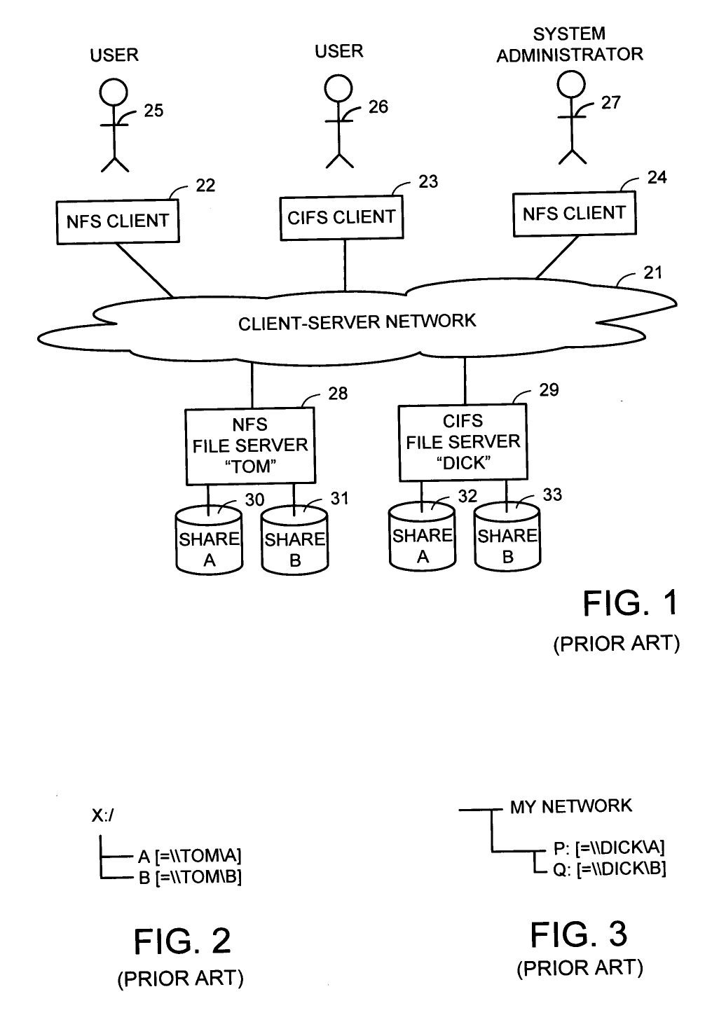

With reference to FIG. 1, there is shown a data processing system including a client-server network 21 interconnecting a number of clients 22, 23, 24 and servers such as network file servers 28, 29. The client-server network 21 may include any one or more of network connection technologies, such as Ethernet, and communication protocols, such as TCP/IP. The clients 22, 23, 24, for example, are workstations such as personal computers for respective human users 25, 26, and 27. The personal computers, for example, use either the Sun Corporation UNIX operating system, or the Microsoft Corporation WINDOWS operating systems.

The clients that use the UNIX operating system, for example, use the NFS protocol for access to NFS file servers, and the clients that use the WINDOWS operating system use the CIFS protocol for access to CIFS file servers. A file server may have multi-protocol functionality, so that it may serve NFS clients as well as CIFS clients. A multi-protocol file server may support additional file access protocols such as NFS version 4 (NFSv4), HTTP, and FTP. Various aspects of the network file servers 28, 29, for example, are further described in Vahalia et al., U.S. Pat. No. 5,893,140 issued Apr. 6, 1999, incorporated herein by reference, and Xu et al., U.S. Pat. No. 6,324,581, issued Nov. 27, 2002, incorporated herein by reference. Such network file servers are manufactured and sold by EMC Corporation, 176 South Street, Hopkinton, Mass. 01748.

In the client-server network 21, the operating systems of the clients 22, 23, 24 see a namespace identifying the file servers 28, 29 and identifying groups of related files in the file servers. In the terminology of the WINDOWS operating system, the files are grouped into one or more disjoint sets called “shares.” In UNIX terminology, such a share is referred to as a file system depending from a root directory. For example, assume that the file server 28 is a NFS file server named “TOM”, and has two shares 30 and 31 named “A” and “B”, respectively. Assume that the file server 29 is a CIFS file server named “DICK”, and has two shares 32 and 33, also named “A” and “B”, respectively. In this case, the UNIX operating system in the NFS client 22 could see the shares of the NFS file server 26 mounted to a root directory “X:” as shown in FIG. 2. The NFS client 22, however, would not see the shares in the CIFS file server 29. The Microsoft Corporation Windows operating system in the CIFS client 23 could see the shares of the CIFS file server 29 mapped to respective drive letters “P:” and “Q:” as shown in FIG. 3. The CIFS client 23, however, would not see the shares in the NFS server 26.

In the client-server network of FIG. 1, further problems arise when another file server must be added to meet an increasing user demand for storage. Various users or user groups would like to see more storage in a particular server that has been assigned to them, rather than worry about whether a new file should be stored in their old server or a new server. There also may be disruption of client service when the system administrator 27 adds a new file server to the client-server network 21. For example, the system administrator must build one or more new file systems or shares on the new file server, and assign the new file system or shares to the users or user groups. More troubling is that the system administrator may need to update the configuration of the clients 22, 23, 24 by mounting or mapping the new file systems or shares to the portion of the network seen by the operating system of each client. The users may need to shut down and restart their client computers in order for the new mappings to take effect. Users may also need to add or map manually new shares after receiving information on the new names or shares.

At this point, even though each of the clients can now access the new file server, the job is still not done. Since the new storage appears at a particular path in the namespace, the system administrator 27 should inform the users 25, 26 about the details of the new shares (name, IP or ID) where they can go to find more storage space. It is up to the individual users to make use of the new storage, by creating files there, or moving files from existing directories over to new directories. Even if the system administrator has a tool to migrate files automatically to the new file server, users must still be informed of the migration. Otherwise they will have no way of finding the files that have moved. Moreover, the system administrator has no easy or automatic way to enforce a policy about which files get placed on the new file server. For example, the new file server may provide enhanced bandwidth or storage access time, so it should be used by the most demanding applications, rather than by less demanding applications such as backup applications.

Overall, the process of adding a new file server turns out to be so expensive, in terms of management cost and disruption to end users, that the system administrator adds much more additional storage for each user group than is necessary to meet current demands in order to avoid frequent installations of new file servers or storage over-provisioning. The cost of the extra storage head-room and resulting lower storage utilization will increase the cost of ownership.

What is desired is a way of adding file server storage capacity to specific user groups without disruption to the users and their clients and applications. It is desired to provide a way of automatically and transparently balancing file server storage usage across multiple file servers, in order to drive up storage usage and eliminate wasted capacity. It is also desired to automatically and transparently match files with storage resources that exhibit an appropriate service level profile, based on business rules established for user groups, allowing users to deploy low-cost storage where appropriate. Files should be automatically migrated without user disruption between service levels as the file data progresses through its natural life-cycle, again based on the business rules established for each user group. User access should be routed automatically and transparently to replicas in case of server or site failures. Point-in-time copies should also be made available through a well-defined interface. In short, end users should be protected from disruption due to changes in data location, protection, or service level, and the end users should benefit from having access to all of their data in a timely and efficient manner.

The present invention is directed to a namespace server that permits the namespace for client access to file servers to be different from the namespace used by the file servers. This provides a single unified namespace for client access that may combine storage in servers accessible only by different file access protocols. This single unified namespace is accessible to clients using different file access protocols. The clients send file access requests to the namespace server, the namespace server translates names in theses file access requests to produce translated file access requests, and the namespace server sends the translated file access requests to the file servers. For a translated file access request sent to a file server, the namespace server receives a response from the file server and transfers the response back to the client. All of the background activity between the namespace server and the file server is not visible to the client, nor the actual location where the file or object is stored. The file can be location agnostic. Although a file may seem to a client to be local and bound to a server, it may actually reside elsewhere. The namespace server directs data and control from and to the actual location or locations of the file.

The name translation permits file server storage capacity to be added for specific user groups without disruption to the users and their clients and applications. For example, when a new server is added, the client can continue to address file access requests to an old server, yet the namespace server can translate these requests to address files in the old server or files in the new servers. The translation process permits a client to continue to access a file by addressing file access requests to the same network pathname for the file as the file is migrated from one file server to another file server due to load balancing, recovery in case of file server failure, or a change in a desired level of service for accessing the file.

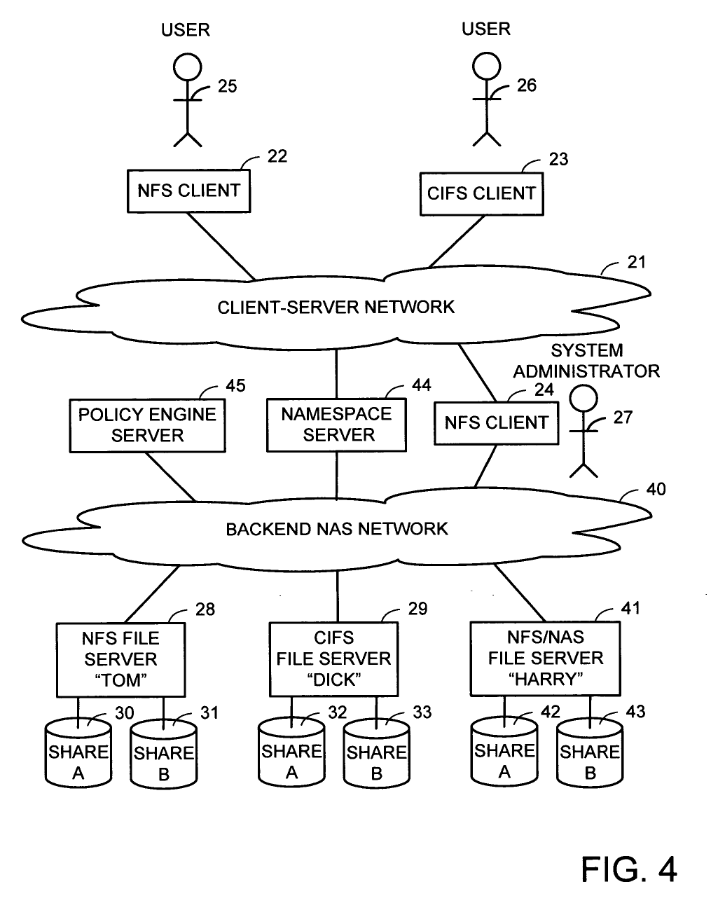

As shown in FIG. 4, the file servers 28, 29 share a backend NAS network 40 separate from the client-server network 21. The namespace server 44 functions as a gateway between the client-server network 21 and the backend NAS network 40. It would be possible, however, for the namespace server 44 simply to be added to a client-server network 21 including the file servers 28 and 29.

FIG. 4 shows that a new server 41 named “HARRY” has been added to the backend NAS network 41. Harry has two shares 42 and 43, named “A” and “B”, respectively. FIG. 3 also shows that the client 24 of the system administrator 27 can directly access the backend NAS network, and the backend NAS network 40 includes a policy engine server 45.

The policy engine server 45 decides when a file in one file server (i.e., a source file server) should be migrated to another file server (i.e., a target file server). The policy engine server 45 is activated at scheduled times, or it may respond to events generated by specific file type, size, owner, or a need for free storage capacity in a file server. Migration may be triggered by these events, or by any other logic. When free storage capacity is needed in a file server, the policy engine server 45 scans file attributes in the file server in order to select a file to be migrated to another file server. The policy engine server 45 may then select a target file server to which the file is migrated. Then the policy engine server sends a migration command to the source file server. The migration command specifies the selected file to be migrated and the selected target file server.

A share, directory or file can be migrated from a source file server to a target file server while permitting clients to have concurrent read-write access to the share, directory or file. The target file server issues directory read requests and file read requests to the source file server in accordance with a network file access protocol (e.g., NFS or CIFS) to transfer the share, directory or file from the source file server to the target file server. Concurrent with the transfer of the share, directory or file from the source file server to the target file server, the target file server responds to client read/write requests for access to the share, directory or file. For example, the target file server maintains a hierarchy of on-line inodes and off-line inodes. The online inodes represent file system objects (i.e., shares, directories or files) that have been completely migrated, and the offline inodes represent file system objects that have not been completely migrated. The target file server executes a background process that walks through the hierarchy in order to migrate the objects of the offline inodes. When an object has been completely migrated, the target file server changes the offline inode for the object to an online inode for the object. Such a migration method is further described in Bober et al., U.S. Ser. No. 09/608,469 filed Jun. 30, 2000, U.S. Pat. No. ______ issued ______, incorporated herein by reference.

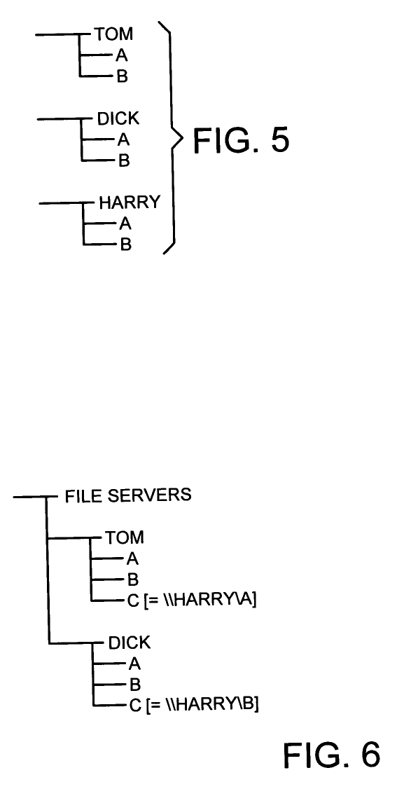

FIG. 5 shows the namespace of the file servers on the backend NAS network. The namespace server, however, is programmed so that the clients on the client-server network see the unified namespace of FIG. 6. It appears to the clients that a new share “C” has been added to the file server “TOM”, and a new share “C” has been added to the file server “DICK”. When the namespace server receives a request for access to the share having the client-server network pathname “\\TOM\C”, the namespace server translates the client-server network pathname to access the share having the backend NAS network pathname “\\HARRY\A”. When the namespace server receives a request for access to the share having the client-server network pathname “\\DICK\C”, the namespace server translates the client-server network pathname to access the share having the backend NAS network pathname “\\HARRY\B”.

A comparison of FIGS. 4, 5 and 6 to FIGS. 1, 2 and 3 shows that the namespace server provides seamless capacity growth for file sets. In general, the namespace server permits seamless provisioning and scaling of capacity of a namespace. Capacity can be added to a namespace with no client disruption. For example, an administrator can create a new file system and add it to the nested mounts structure without any disruption to all of the clients that access the share. A system administrator 12 can also seamlessly “scale back” the capacity of a file set, which is very important in a charge-back environment. Moreover, virtual file sets can be mapped to physical storage pools, where each pool provides a distinct quality of service. Storage management becomes a problem of assigning the correct set of physical storage pools to back a virtual file set. For example the disks behind each file system or share can be of different performance characteristics like: Fibre Channel, AT Attachment (ATA), or Serial ATA (SATA).

The namespace server can be programmed to translate not only network pathnames but also the high-level format of the file access requests. For example, a NFS client sends a file access request to the namespace server using the NFS protocol, and the namespace server translates the request into one or more CIFS requests that are transmitted to a CIFS file server. The namespace server receives one or more replies from the CIFS file server, and translates the replies into a NFS reply that is returned to the client. In another example, a CIFS client sends a file access request to the namespace server using the CIFS protocol, and the namespace server translates the request into one or more NFS requests that are transmitted to a NFS file server. The namespace server receives one or more replies from the NFS file server, and translates the replies into a CIFS reply that is returned to the client.

The namespace server could also be programmed to translate NFS, CIFS, HTTP, and FTP requests from clients in the client-server network into NAS commands sent to a NAS server in the backend NAS network. The namespace server could also cache files in a locally owned file system to the extent that local disk space and cache memory would be available in the namespace server. A client could be served directly by the namespace server.

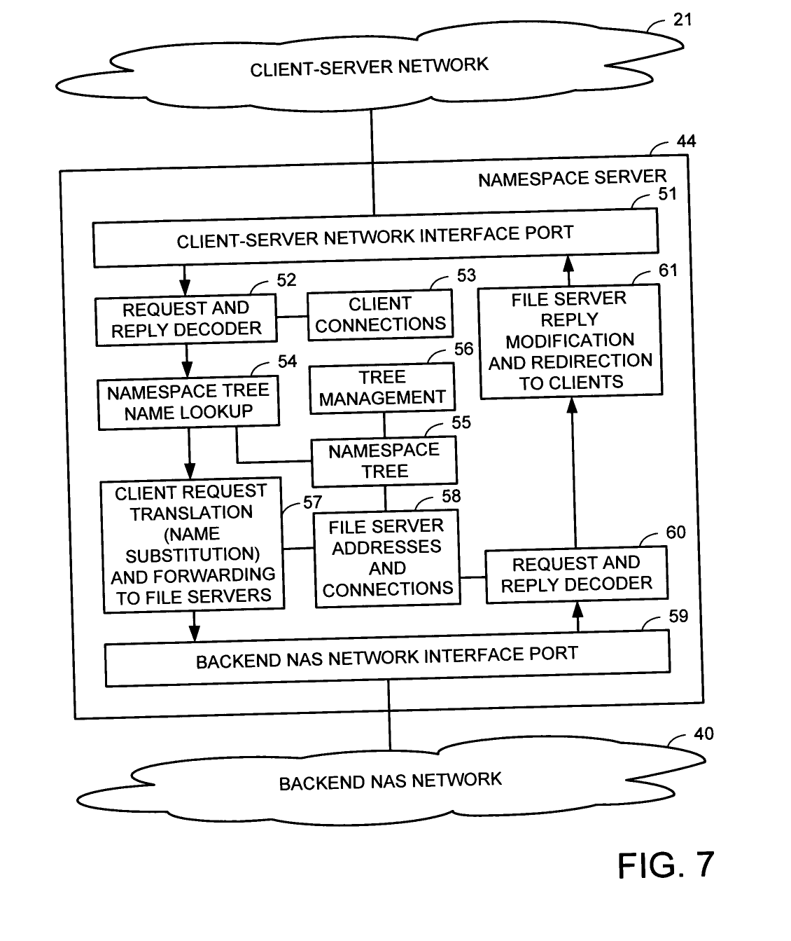

FIG. 7 shows a functional block diagram of the namespace server 44. The namespace server has a client-server network interface port 51 to the client-server network 21. A request and reply decoder 52 decodes requests and replies that are received on the client-server network interface port 51. For file access requests and replies in accordance with a high-level connection oriented protocol such as CIFS, the namespace server maintains a database 53 of client connections. The programming for the request and reply decoder 52 is essentially the same as the programming for the NFS and CIFS protocol layers of a multi-protocol file server, since the namespace server 44 is functioning as a proxy server when receiving file access requests from the network clients. The request and reply decoder 52 recognizes client-server network pathnames in the client requests and replies, and uses these pathnames in a namespace tree name lookup 54 that attempts to trace the pathname thorough a namespace tree 55 programmed in memory of the namespace server. The namespace tree 55 provides translations of client-server network pathnames into corresponding backend NAS network pathnames for offline inodes in the namespace tree. A tree management program 56 facilitates configuration of the namespace tree 55 by the systems administrator.

Client request translation and forwarding 57 to file servers includes name substitution, and also format translation if the client and server use different high-level file access protocols. The programming for the client request translation and forwarding to NFS or NFSv4 file servers includes the NFS or NFSv4 protocol layer software found in an NFS or NFSv4 client since the namespace server is acting as a NFS or NFSv4 proxy client when forwarding the translated requests to NFS or NFSv4 file servers. The programming for the client request translation and forwarding to CIFS file servers includes the CIFS protocol layer software found in a CIFS client since the namespace server is acting as a CIFS proxy client when forwarding the translated requests to CIFS file servers. The programming for the client request translation and forwarding to HTTP file servers includes the HTTP protocol layer software found in an HTTP client since the namespace server is acting as an HTTP proxy client when forwarding the translated requests to HTTP file servers.

A database of file server addresses and connections 58 is accessed to find the network protocol or machine address for a particular file server to receive each request, and a particular protocol or connection to use for forwarding each request to each file server. For example, the connection database 58 for the preferred implementation includes the following fields: for CIFS, the Server Name, Share name, User name, Password, Domain Server, and WINS server; and for NFS, the Server name, Path of exported share, Use Root credential flag, Transport protocol, Secondary server NFS/Mount port, Mount protocol version, and Local port to make connection. Using the connection database avoids storing all the credential information in the offline inode.

A backend NAS network interface port 59 transmits the translated file access requests to file servers on the backend NAS network 40. A request and reply decoder 60 receives requests and replies from the backend NAS network 40. File server reply modification and redirection to clients 61 includes modification in accordance with namespace translation and also format translation if the reply is from a server that uses a different high-level file access protocol than is used by the client to which the reply is directed. The client-server network port 51 transmits the replies to the clients over the client-server network 21.

In a preferred implementation, whenever the namespace server returns a file identifier (i.e., a file handle or fid) to a client, the namespace tree will include an inode for the file. Therefore, the process of a client-server network namespace lookup for the pathname of a directory or file in the backend NAS network will cause instantiation of an inode for the directory or file if the namespace tree does not already include an inode for the directory or file. This eliminates any need for the file identifier to include any information about where an object (i.e., a share, directory, or file) referenced by the file identifier is located in the backend NAS network. Instead, the namespace server may issue file identifiers that identify inodes in the namespace tree in a conventional fashion. Consequently, an object referenced by a file identifier issued to a client can be migrated from one location to another in the backend NAS network without causing the file identifier to become stale. The growth of the namespace tree caused by the issuance of file identifiers could be balanced by a background pruning task that removes from the namespace tree leaf inodes for directories and files that are in the file servers in the backend NAS network and have not been accessed for a certain length of time in excess of a file identifier lifetime.

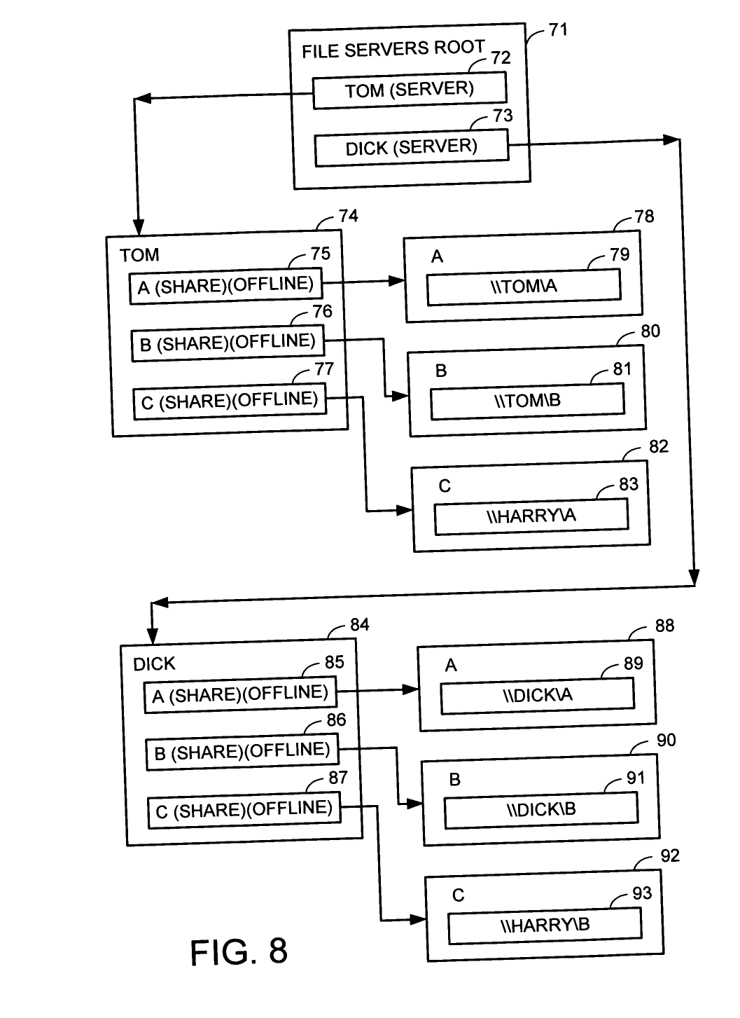

FIG. 8 shows the namespace tree of FIG. 5 programmed into the namespace server of FIG. 7 as a hierarchical data structure of “online” inodes and “offline” inodes. The “online” inodes may represent virtual file systems, virtual shares, virtual directories, or virtual files in the client-server network namespace. The “offline” inodes may represent file servers in the backend NAS network, or shares, directories, or files in the file servers in the backend NAS network. Leaf nodes in the namespace tree of FIG. 8 are offline inodes. The namespace tree has a root inode 71 representing all of the virtual file systems on the backend NAS network that are accessible to the client-server network through the namespace server. The root inode 71 has an entry 72 pointing to an inode 74 for a virtual file system named “TOM”, and an entry 73 pointing to an inode 84 for a virtual file system named “DICK”.

The inode 74 for the virtual file system “TOM” has an entry 75 pointing to an offline share named “A” in the client-server network namespace, an entry 76 pointing to an offline share named “B” in the client-server network namespace, and an entry 77 pointing to an offline share named “C” in the client-server network namespace. The offline inode 78 has an entry 79 indicating that the offline share having the pathname “\\TOM\A” in the client-server network namespace has a pathname of “\\TOM\A” in the backend NAS network namespace. The offline inode 80 has an entry 81 indicating that the offline share having a pathname “\\TOM\B” in the client-server network namespace has a pathname of “\\TOM\B” in the backend NAS network namespace. The offline inode 82 has an entry 83 indicating that the offline share having the pathname “\\TOM\C” in the client-server network namespace has a pathname of“\HARRY\A” in the backend NAS network namespace.

The inode 84 for the virtual file system “DICK” has an entry 85 pointing to an offline share named “A” in the client-server network namespace, an entry 86 pointing to an offline share named “B” in the client-server network namespace, and an entry 87 pointing to an offline share named “C” in the client-server network namespace. The offline inode 88 has an entry 89 indicating that the offline share having the pathname “\\DICK\A” in the client-server network namespace has a pathname of “\DICK\A” in the backend NAS network namespace. The offline inode 90 has an entry 91 indicating that the offline share having the pathname “\\DICK\B” in the client-server network namespace has a pathname of“\\DICK\B” in the backend NAS network namespace. The offline inode 92 has an entry 93 indicating that the offline share having the pathname “\\DICK\C” in the client-server network namespace has a pathname of “\HARRY\B” in the backend NAS network namespace.

In practice, the inodes in the namespace tree can be inodes of a UNIX-based file system, and conventional UNIX facilities can be used for searching through the namespace tree for a given pathname in the client-server network namespace. However, the inodes of a UNIX-based file system include numerous fields that are not needed, so that the inodes have excess memory capacity, especially for the online inodes. Considerable memory savings can be realized by eliminating the unused fields from the inodes.

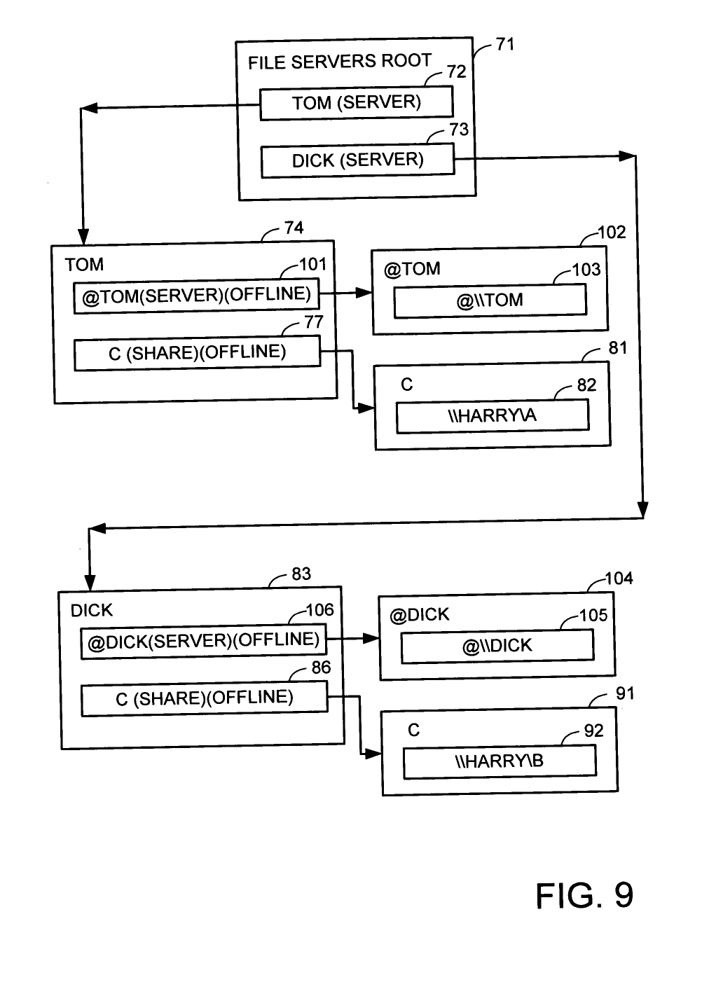

FIG. 9 shows another way of programming the namespace tree of FIG. 6 into the namespace server. In this example, the inode 74 for the virtual file system “TOM” includes an entry 101 representing shares incorporated by reference from the file server “TOM” in the backend NAS network. The symbol “169” at the beginning of an inode name in the namespace tree is interpreted by the namespace tree name lookup (54 in FIG. 7) as an indication that the inode name is to be hidden (i.e., excluded) from the client-server network namespace, and the pointer entries in this inode are to be incorporated by reference into the parent inode that has an entry pointing to this inode. Similarly, if the symbol “@” is at the beginning of a backend NAS network pathname in an offline inode, then the pointer entries in this offline inode are considered to be the pointer entries that are the contents of the object at this backend NAS network pathname. Thus, the offline inode 102 having the pointer entry 103 containing the pathname “@\\TOM” is considered to have pointers to all of the shares in the server having the backend NAS network pathname “\\TOM”. Consequently, these pointers are incorporated by reference into the inode 74. In a similar fashion, the offline inode 104 having the pointer entry 105 containing the pathname “@\\DICK” is considered to have pointers to all of the shares in the server having the backend NAS network pathname “\\DICK”. Due to the entry 106 in the inode 83, these pointers are incorporated by reference into the inode 83.

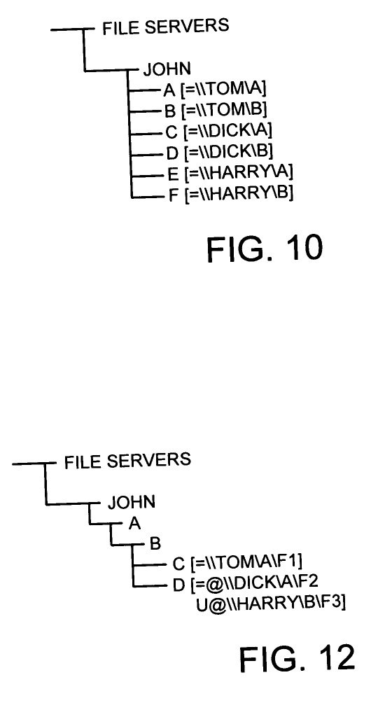

FIG. 10 shows another example of a namespace tree as seen by clients, in which the shares of three file servers (TOM, DICK, and HARRY) appear to reside in a single virtual file system named “JOHN”.

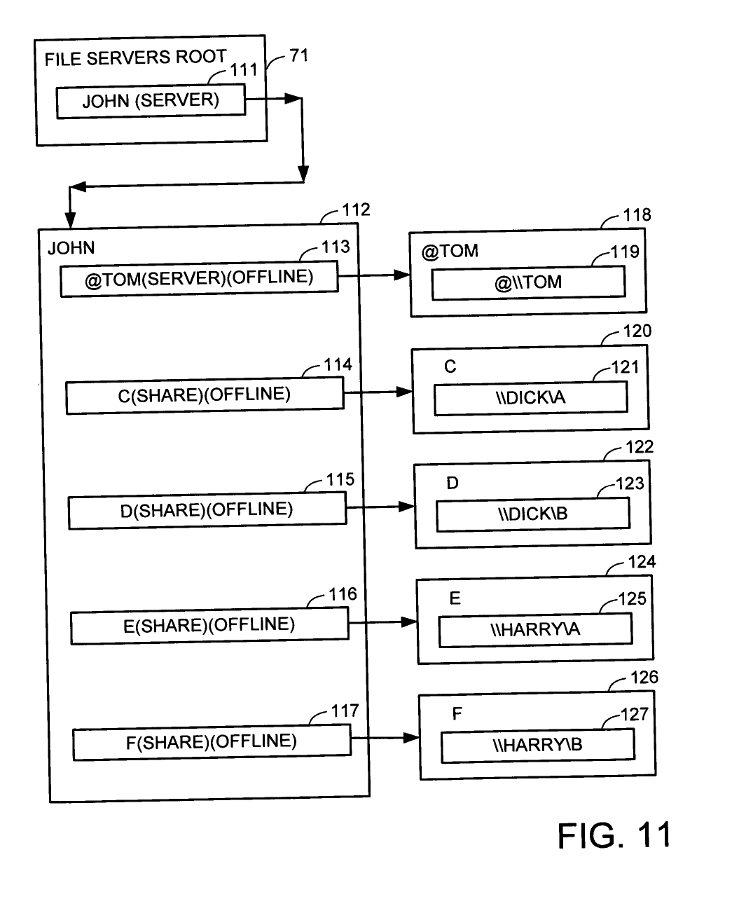

FIG. 11 shows a way of programming the namespace tree of FIG. 10 into the namespace server. In this example, the root inode 71 has an entry 111 pointing to an inode 112 for a virtual file system named “JOHN”. The inode 112 includes an entry 113 pointing to and incorporating the contents of an offline inode 118 named “@TOM”, an entry 114 pointing to an offline inode 120 named “C”, an entry 115 pointing to an offline inode 122 named “D”, an entry 116 pointing to an offline inode 124 named “E”, and an entry 117 pointing to an offline inode 126 named “C”. The offline inode 118 contains an entry 119 pointing to and incorporating the shares of the file server having a backend NAS network pathname of “\\TOM”. The offline inode 120 contains an entry 121 pointing to the share having a backend NAS network pathname of “\\DICK\A”. The offline inode 122 contains an entry 123 pointing to the share having a backend NAS network pathname of “\\DICK\B”. The offline inode 124 contains an entry 125 pointing to the share having a backend NAS network pathname of “\\HARRY\A”. The offline inode 126 contains an entry 127 pointing to the share having a backend NAS network pathname of “\\HARRY\B”.

FIG. 12 shows yet another example of a namespace tree as seen by clients. In this example, a virtual directory named “B” includes entries for files named “C” and “D” that reside in different file servers. The virtual file named “D” contains data from files in the file servers “DICK” and “HARRY”.

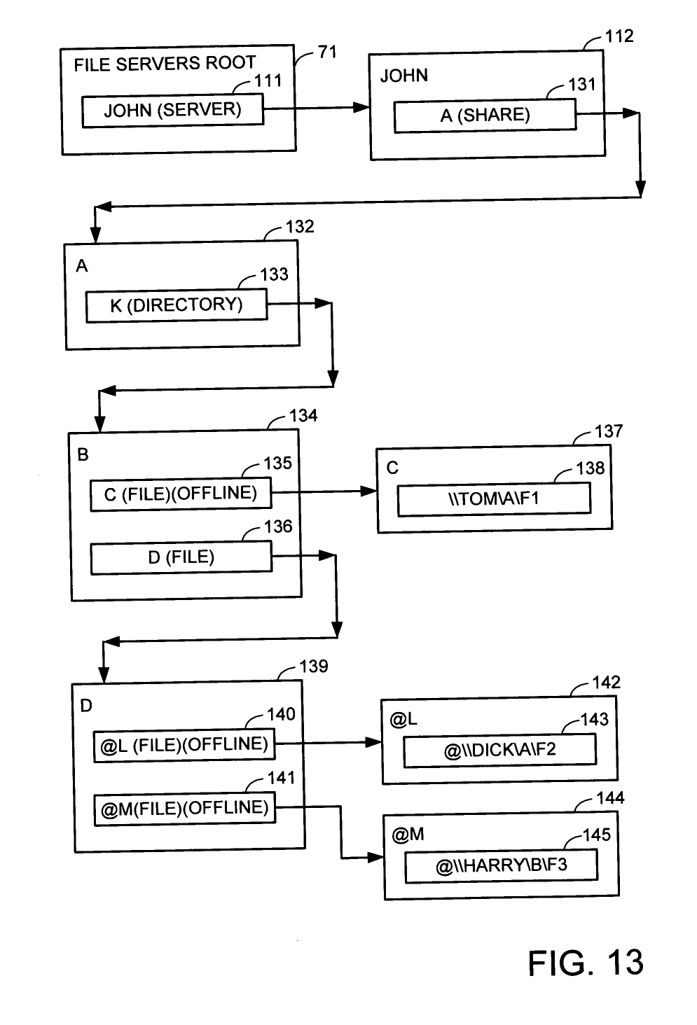

FIG. 13 shows a way of programming the namespace tree of FIG. 12 into the namespace server. In this example, the root inode 71 has an entry 111 pointing to an inode 112 for a virtual file system named “JOHN”. The inode 112 has an entry 131 pointing to an inode 132 for a virtual share named “A”. The inode 132 has an entry 133 pointing to an inode 134 for a virtual directory named “B”. The inode 134 has a first entry 135 pointing to an offline inode 137 named “C”. The offline inode 137 has an entry 138 pointing to a file having a backend NAS network pathname “\\TOM\A\F1”.

The inode 134 has a second entry 136 pointing to an inode 139 for a virtual file named “D”. The inode 139 includes a first entry 140 pointing to an offline inode 142 named “@L”. The offline inode 142 has an entry 143 pointing to the contents of a file having a backend NAS network pathname of “\\DICK\A\F2”. The inode 139 has a second entry 141 pointing to an offline inode 144 named “@M”. The offline inode 144 has an entry 145 pointing to the contents of a file having a backend NAS network pathname of “\\HARRY\F3”.

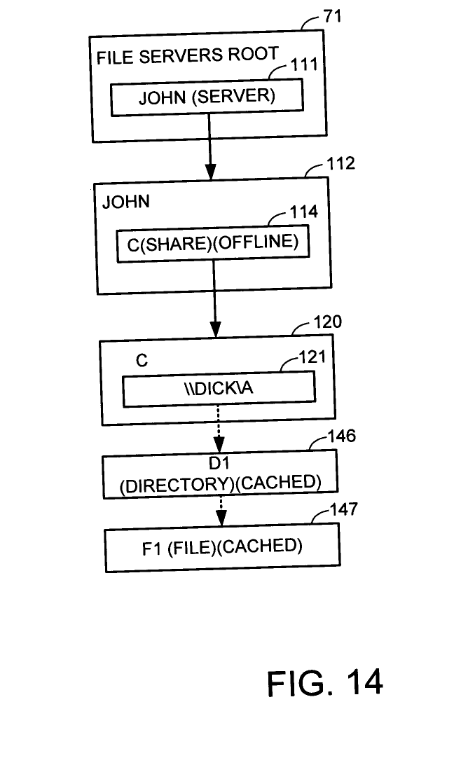

FIG. 14 shows a dynamic extension of the namespace tree (of FIG. 11) resulting from a lookup process for a specified file to return a file identifier to a client (i.e, a file handle to a NFS client or a file id (fid) to a CIFS client). In this example, the file is specified by a client-server network pathname of “\\JOHN\C\D1\F1”, and the file has a backend NAS network pathname of“\\DICK\A\D1\F1”. The lookup process causes the instantiation of a cached inode 146 for the directory D1 and the instantiation of a cached inode 147 for the file F1.

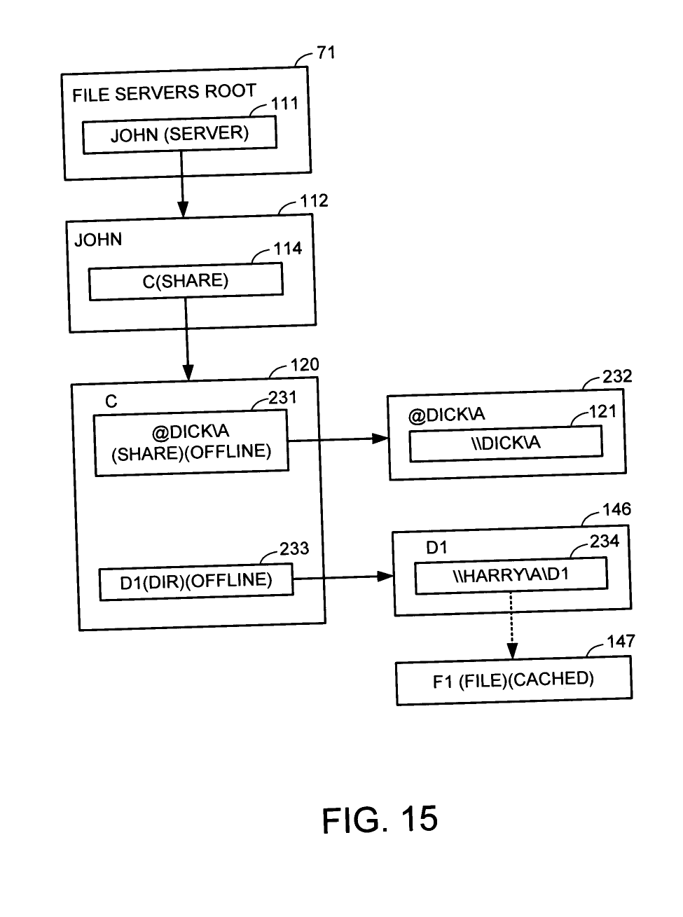

FIG. 15 shows a reconfiguration of the namespace tree (of FIG. 14) resulting from a migration of the directory D1 from the file server “DICK” to the file server “HARRY”. In this example, the directory D1 is migrated from an old backend NAS network pathname of “\\DICK\A\D1” to a new backend NAS network pathname “\\HARRY\A\D1”. The node 120 named “C” is changed from “offline” to “online” so that it may contain an entry 231 pointing to an offline node 232 for the contents of the offline share “\\DICK\A” and it may also contain an entry 233 pointing to an offline node for the offline directory “\\HARRY\A\D1”. The node 146 for the directory D1 is changed from “cached” to “offline” so that it becomes part of the configured portion of the namespace tree, and the node 146 for the directory D1 includes an entry 234 containing the new backend NAS network pathname “\\HARRY\A\D1”.

For NFS, at mount time a handle to a root directory is sent to the client. In a client-server network, user identity and access permissions are checked before the handle to the root directory is sent to the client. For subsequent file accesses, the handle to the root directory is unchanged. A mount operation is also performed in order to obtain a handle for a share. In order to access a file, an NFS client must first obtain a handle to the file. This is done by resolving a full pathname to the file by successive directory lookups, culminating in a lookup which returns the handle for the file. The client uses the file handle for the file in a request to read from or write to the file.

For CIFS, a typical client request—server reply sequence for access to a file includes the following:

1. SMB_COM_NEGOTIATE. This is the first message sent by the client to the server. It includes a list of Server Message Block (SMB) dialects supported by the client. The server response indicates which SMB dialect should be used.

2. SMB_COM_SESSION_SETUP_ANDX. This message from the client transmits the user's name and credentials to the server for verification. A successful server response has a user identification (Uid) field set in SMB header used for subsequent SMBs on behalf of this user.

3. SMB_COM_TREE_CONNECT_ANDX. This message from the 6 client transmits the name of the disk share that the client wants to access. A successful server response has a Tid field set in a SMB header used for subsequent SMBs referring to this resource.

4. SMB_COM_OPEN_ANDX. This message from the client transmits the name of the file, relative to Tid, the client wants to open. A successful server response includes a file id (Fid) the client should supply for subsequent operations 12 on this file.

5. SMB_COM_READ. This message from the client transmits the Tid, Fid, file offset, and number of bytes to read. A successful server response includes the requested file data.

6. SMB_COM_CLOSE. The message from the client requests the server to close the file represented by Tid and Fid. The server responds with a success code.

7. SMB_COM_TREE_DISCONNECT. This message from the client requests the client to disconnect from the resource represented by Tid.

By using a CIFS request batching mechanism (called the “AndX” mechanism), the second to sixth messages in this sequence can be combined into one, so there are really only three round trips in the sequence, and the last one can be done asynchronously by the client.

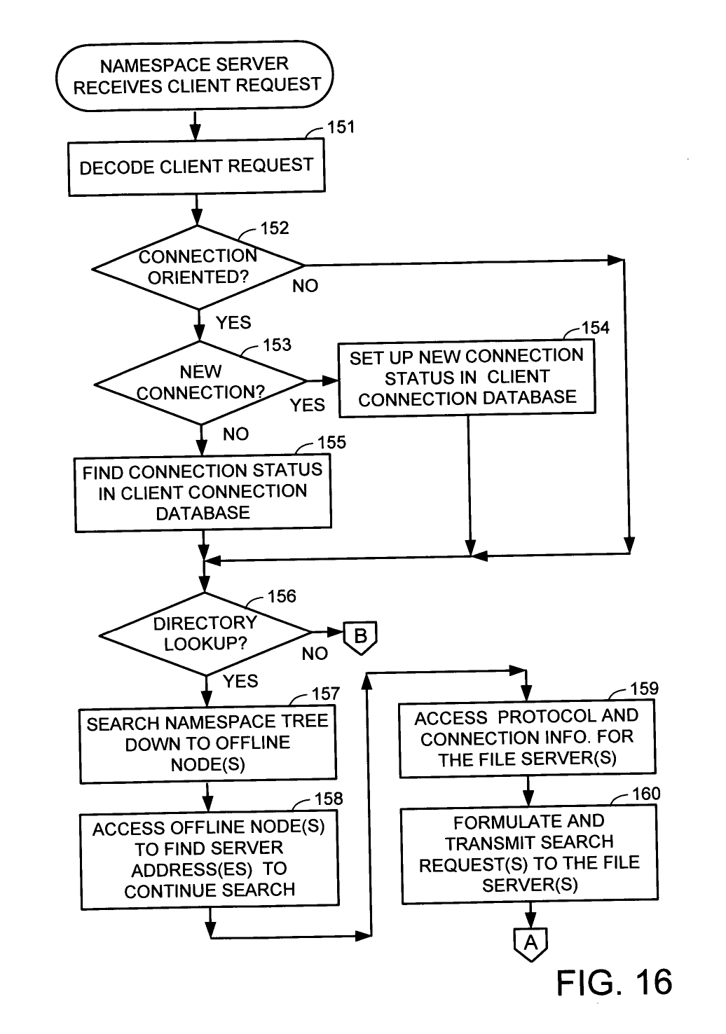

FIGS. 16 to 18 together show a procedure used by the namespace server for responding to a client request. In a first step 151, the namespace server decodes the client request. In step 152, if the request is in accordance with a connection-oriented protocol such as CIFS, then execution continues to step 153. If a connection with the client has not already been established for handling the request, then execution branches from step 153 to step 154. In step 154, the namespace server sets up a new connection in a client connection database in the namespace server. If a connection has been established with the client, then execution continues from step 153 to step 155 to find the connection status in the client connection database. Execution continues from steps 154 and 155 to step 156. Execution also continues to step 156 from step 152 if the request is not in accordance with a connection oriented protocol.

In step 156, if the request requires a directory lookup, then execution continues to step 157. For example, for a NFS client, the namespace server performs a directory lookup for a server share or a root file system in response to a mount request, and for a file in response to a file name lookup request, resulting in the return of a file handle to the client. For a CIFS client, the namespace server performs a directory lookup for a server share in response to a SMB_COM_TREE_CONNECT request, and for a file in response to a SMB_COM_OPEN request. In step 157, the namespace server searches down the namespace tree along the path specified by the pathname in the client request until an offline inode is reached. Once an offline inode is reached, in step 158 the namespace server accesses the offline inode to find a backend NAS network pathname of a server in which the search will be continued. In addition to the server address, the offline inode has a pointer to protocol and connection information for this server in which the search will be continued. In step 159, this pointer is used to obtain this protocol and connection information from the connection database. In step 160, this protocol and connection information is used to formulate and transmit a server share or file lookup request for obtaining a Tid, fid, or file handle corresponding to the backend NAS network pathname from the offline inode.

The search of the namespace tree in the namespace server may reach an inode having entries that point to the contents of directories in more than one of the file servers. In this case, in step 160, it is possible for the namespace server to forward concurrently a pathname search request to each of the file servers. As soon as any one of the servers returns a reply indicating that a successful match has been found, the namespace server could issue a request canceling the searches by the other file servers.

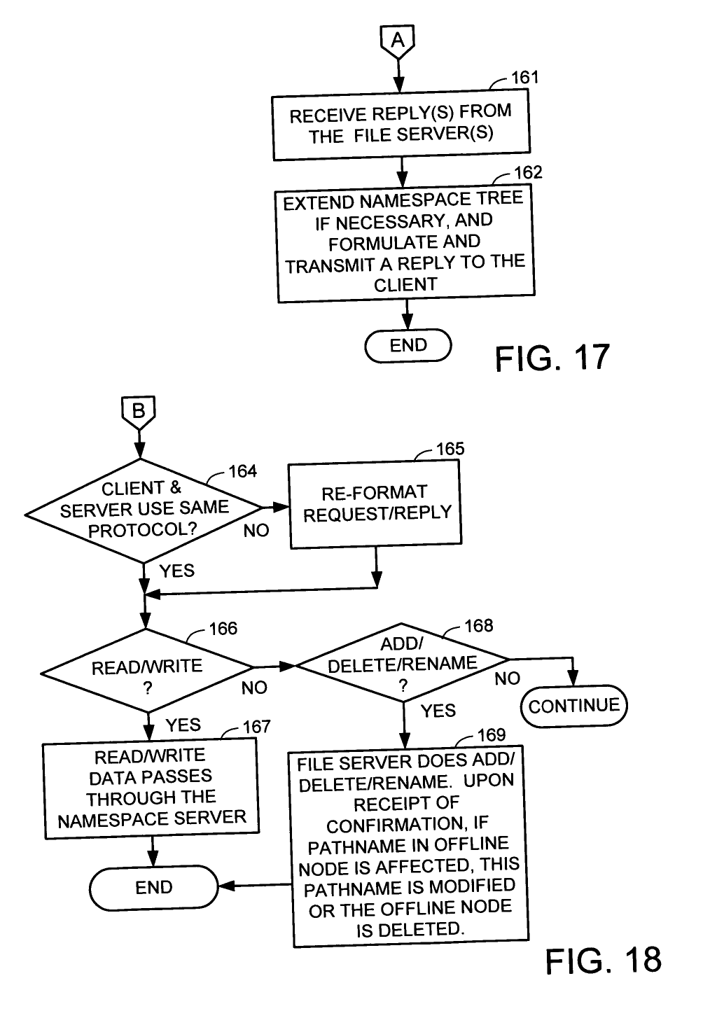

In step 161 of FIG. 17, the namespace server receives the reply or replies from the file server or file servers. In step 162, the namespace server extends the namespace tree if needed by adding any not-yet cached inodes for directories and files along the successful search path in the file server, as shown and introduced above with reference to FIG. 14, and then the namespace server formulates and transmits a reply to the client, for example a reply including a file identifier such as a NFS file handle or a CIFS fid.

For the case of a SMB_COM_SESSION_SETUP request as well as a mount request, the actual authentication and authorization of a client could be deferred until the client specifies a share or file system and a search of the pathname for the specified share or root file system is performed in the file server for the specified share or root file system. In this case, a client would have only read-only access to information in the namespace server until the client is authenticated and authorized by one of the file servers. However, an entirely separate authentication mechanism could be used in the tree management programming (56 in FIG. 7) of the namespace server in order to permit a system administrator to initially configure or to reconfigure the namespace tree.

In step 156 of FIG. 16, if the client request does not require a directory lookup, then execution continues to step 164 of FIG. 18. In step 164, if the client and the file server do not use the same protocol, then execution branches to step 165 to re-format the request from the client. The reply to the client may also have to be reformatted. After step 165, or if the client and server are found to use the same protocol in step 164, execution continues to step 166.

In the preferred implementation in which a file identifier (i.e., file handle or fid) from or to a client identifies an inode in the namespace tree, if a request or reply received by the namespace server includes a file identifier, then the namespace server will perform a file handle substitution because the corresponding file handle to or from a file server identifies a different inode in a file system maintained by the file server. In order to facilitate this file identifier substitution, when a file server returns a file identifier to the namespace server as a result of a directory lookup for an object specified by a backend NAS network pathname, the namespace server stores the file identifier in the object's inode in the namespace tree. Also, the corresponding file system handle or TID for accessing the object in the file server is associated with the object's inode in the namespace tree if this inode is an offline inode, or otherwise the corresponding file system handle or TID for accessing the object in the file server is associated with the offline inode that is a predecessor of the object's inode in the namespace tree.

In step 166, for a read or write request, execution continues to step 167. In step 167, the read or write data passes through the namespace server. For a read request, the requested data passes through the namespace server from the backend NAS network to the client-server network. For a write request, the data to be written passes through the namespace server from the client-server network to the backend NAS network.

In step 166, if the client request is not a read or write request, then execution continues to step 168. In step 168, if the client request is a request to add, delete, or rename a share, directory, or file, then execution continues to step 169. A typical user may have authority to add, delete, or rename a share, directory, or file in one of the file servers. In this case, the file server will check the user's authority, and if the user has authority, the file server will perform the requested operation. If the requested operation requires a corresponding change or deletion of a backend NAS network pathname in the namespace tree, then the namespace server performs the corresponding change upon receipt of a confirmation from the file server. A deletion of a backend NAS network pathname from an offline inode may result in an offline inode empty of entries, in which case the off line inode may be deleted along with deletion of a pointer to it in its parent inode in the namespace tree.

The namespace server may also respond to client requests for metadata of virtual inodes in the namespace tree. Virtual inodes can serve as namespace junctions that are not written into, but which aggregate file systems. Once the metadata information in the namespace tree becomes too large for a single physical file system to hold, a virtual inode can be used to link together more than one large physical file system in order to continue to scale the available namespace. In many cases the metadata of a virtual inode can be computed or reconstructed from metadata stored in the file servers that contain the objects referenced by the offline inodes that are descendants of the virtual inode. Once this metadata is computed or reconstructed, it can be cached in the namespace tree. The virtual inodes could also have metadata that is configured by the system administrator or updated in response to file access. For example, the system administrator could configure a quota for a virtual directory, and a “bytes used” could be maintained for the virtual directory, and updated and checked against the quota each time a descendant file is added, deleted, extended, or truncated.

The namespace server may also respond to tree management commands from an authorized system administrator, or a policy engine or file migration service of a file server in the backend NAS network. For example, file migration transparent to the clients at some point requires a change in the storage area pathname in an offline inode. If the new or old storage area pathname is a CIFS server, the server connection status should also be updated.

The namespace server may also respond to a backend NAS network pathname change request from the backend NAS network for changing the translation of a client-server network pathname from a specified old backend NAS network pathname to a specified new backend NAS network pathname. The namespace server searches for offline inode or inodes in the namespace tree from which the old backend NAS network pathname is reached. Upon finding such an offline inode, if an entry of the inode includes the old backend NAS network pathname, then the entry is changed to specify the new backend NAS network pathname.

The namespace tree could be constructed so that the pathname of every physical file in every file server is found in at least one offline inode of the namespace tree. This would simplify the process of changing backend NAS network pathnames, but it would result in the namespace server having to store and access a very large directory structure. For the general case where the offline inodes represent shares or directories, an entry of an offline inode may specify merely a beginning portion of the old backend NAS network pathname. In this case, this offline inode represents a “mount point” or root directory of a file tree that includes the object identified by the old backend NAS network pathname. The remaining portion of the old backend NAS network pathname is the same as an end portion of the client-server pathname. In this case, the namespace tree is reconfigured by the addition of inodes to perform the same client-server network to storage-area network namespace translation as before and so that the old backend NAS network pathname appears in an entry in an added offline inode. Then, the old backend NAS network pathname in this added offline inode is changed to the new backend NAS network pathname. A specific example of this process was described above with reference to FIG. 15.

In the general case, the namespace tree is reconfigured to perform the same namespace translation as before by adding a new offline inode to contain the old backend NAS network pathname. In addition, the offline inode representing the “mount point” is changed to a virtual inode containing entries pointing to newly added offline inodes for all of the objects in the root inode that are not the object having the old backend NAS network pathname or a predecessor directory for the object having the old storage area pathname. In a similar fashion, a virtual inode is created in the namespace tree for each directory name in the pathname between the virtual inode of the “mount point” and the offline inode for the object having the old backend NAS network pathname. Each of these virtual inodes are provided with entries pointing to new offline inodes for the files or directories that are not the object having the old backend NAS network pathname or a predecessor directory for the object having the old storage area pathname.

To facilitate the search for offline inode or inodes in the namespace tree from which the old backend NAS network pathname is reached, the namespace server may maintain an index to the backend NAS network pathnames in the offline inodes. For example, this index could be maintained as a hash index. Alternatively, the index could be a table of entries, in which each entry includes a pathname and a pointer to the offline inode where the pathname appears. The entries could be maintained in alphabetical order of the pathnames, in order to facilitate a binary search.

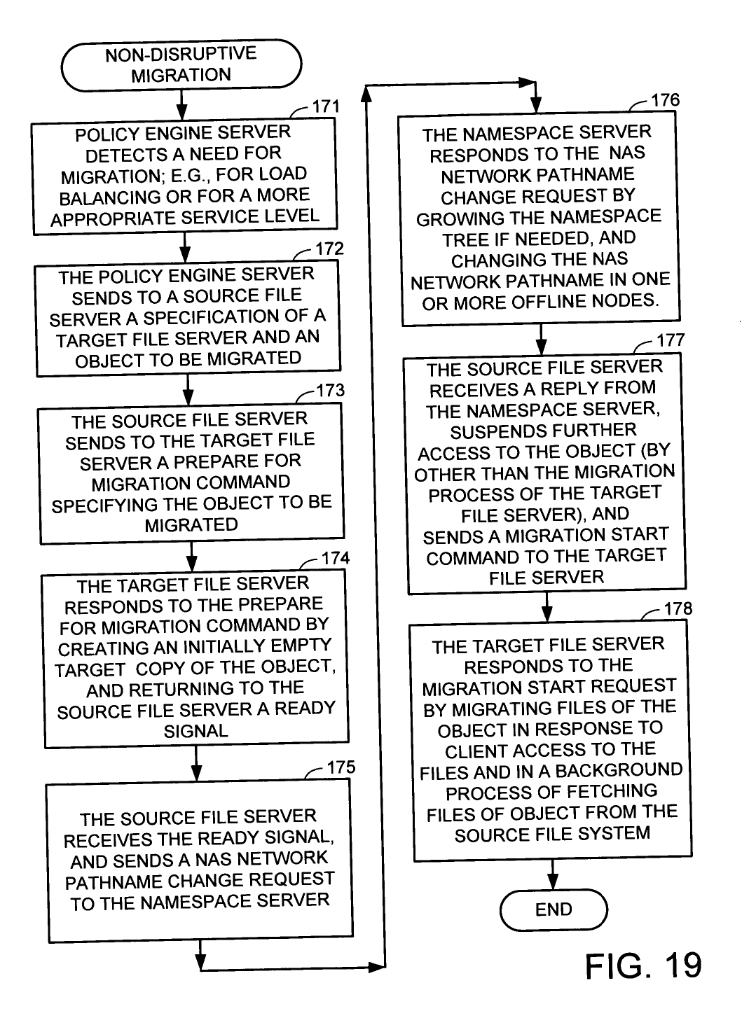

FIG. 19 shows a method of non-disruptive file migration in the system of FIG. 4. In a first step 171 of FIG. 19, the policy engine server detects a need for file migration; for example, for load balancing or for a more appropriate service level. The policy engine selects a particular source file server, a particular file system in the source file server, and a particular target file server to receive the file system from the source file server. In step 172, the policy engine server returns to the source file server a specification of the target file server and the file system to be migrated. In step 173, the source file server sends to the target file server a “prepare for migration” command specifying the file system to be migrated. In step 174, the target file server responds to the “prepare for migration” command by creating an initially empty target copy of the file system, and returning to the source file server a ready signal. In this prepared state, the target file server will queue-up any client requests to access the target file system until receiving a “migration start” command from the source file server.

In step 175, the source file server receives the ready signal, and sends a backend NAS network pathname change request to the namespace server. In step 176, the namespace server responds to the namespace change request by growing the namespace tree if needed for the old pathname to appear in an offline inode of the namespace tree, and changing the old pathname to the new pathname wherever the old pathname appears in the offline inodes of the namespace tree. In step 177, the source file server receives a reply from the namespace server, suspends further access to the file system by the namespace server or clients other than migration process of the target file server, and sends a “migration start” request to the target file server. In step 178, the target file server responds to the “migration start” request by migrating files of the file system on a priority basis in response to client access to the files and in a background process of fetching files of the file system from the source file system.

The policy engine could also be involved in a background process of pruning the namespace tree by migrating all files in the same virtual directory of the namespace tree to the same file server, creating a directory in the file server corresponding to the virtual directory, replacing the virtual directory with an offline inode, and then removing the offline nodes of the files from the namespace tree.

In the above examples, each offline inode in the namespace tree has had a single entry pointing to an object of a file server. When the offline inode represents a file, it may be appropriate to permit the offline inode to have one or more entries, each designating a separate physical copy of the file at a different physical location. When reading the file, if the file is not available at one location because of failure or a heavy access loading or loss of a network connection, then the file can be accessed at one of the other locations. When writing to the file, the file can be written to at all locations, as shown and further described below with reference to FIG. 18.

The write operation will complete without error, and the namespace server will return an acknowledgement of successful completion to the client, only after all of the copies have been updated successfully, and acknowledgements of such successful completion have been returned by the file servers at all of the locations to the namespace server. See, for example, the discussion of synchronous remote mirroring in Yanai et al., U.S. Pat. No. 6,502,205 issued Dec. 31, 2002, incorporated herein by reference. The writing of the file to all of the locations could also be done by the namespace server writing to a local file, and using a replication service to replicate the changes in the local file to file servers in the backend NAS network. See, for example, Raman et al., “Replication of remote copy data for internet protocol (IP) transmission,” U.S. Patent Application publication no. 20030217119 published Nov. 20, 2003, incorporated herein by reference.

If the write operation does not complete at any location, then the copy at that location will become invalid. In this case the corresponding entry in the offline inode can be removed or flagged as invalid. The number of copies that should be made and maintained for a file could be dynamically adjusted by the policy engine server. For example, the namespace server could collect access statistics and store the access statistics in the offline inodes as file attributes. The policy engine server could collect and compare these statistics among the files in order to dynamically adjust the number of copies that should be made.

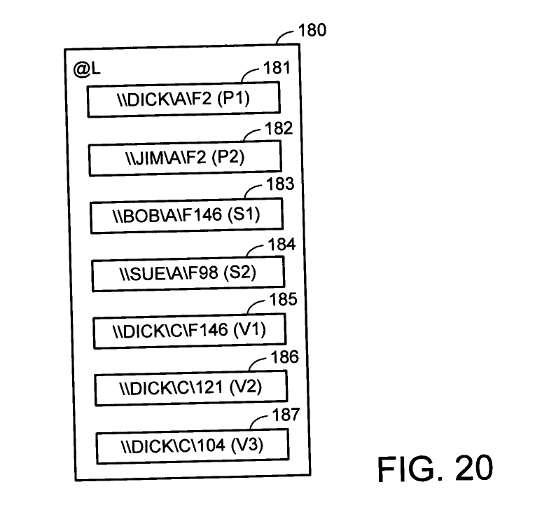

FIG. 20 shows an example of an offline inode 180 having multiple entries 181-187 specifying pathnames for primary copies that are synchronously mirrored copies, secondary copies that are asynchronously mirrored copies, and point-in-time versions of a file. Each entry has a file type attribute, and a service level attribute. For example, a primary copy (181, 182) is indicated by a “P” value for the file type attribute, a secondary copy (183, 184) is indicated by an “S” value for the file type attribute, and a point-in-time version (185, 186, 187) is indicated by a “V” value for the file type attribute. The secondary copies may be generated from the primary copies by asynchronous remote mirroring facilities in the file servers containing the primary and secondary copies. For example, an asynchronous remote mirroring facility is described in Yanai et al., U.S. Pat. No. 6,502,205 issued Dec. 31, 2002, incorporated herein by reference.

The point-in-time versions are also known as snapshots or checkpoints. A snapshot copy facility can create a point-in-time copy of a file while permitting concurrent read-write access to the file. Such a snapshot copy facility, for example, is described in Kedem U.S. Pat. No. 6,076,100, incorporated herein by reference, and in Armangau et al., U.S. Pat. No. 6,792,518, issued Sep. 14, 2004, incorporated herein by reference. The service level attribute is a numeric value indicating an ordering of the copies in terms of accessibility for primary and secondary copies, and time of creation for the point-in-time versions.

For an offline inode having more than one entry, the namespace server may access the file type and service level attributes in order to determine which copy or version of the file to access in response to a client request. For example, the namespace server will usually reply to a file access request from a client by accessing the primary copy having the highest level of accessibility, as indicated by the service level attribute, unless this primary copy is already busy servicing a prior file access request from the namespace server. An appropriate scheduling procedure, such as “round-robin” weighted by the service level attribute, is used for selecting the primary copy to access for the case of concurrent access.

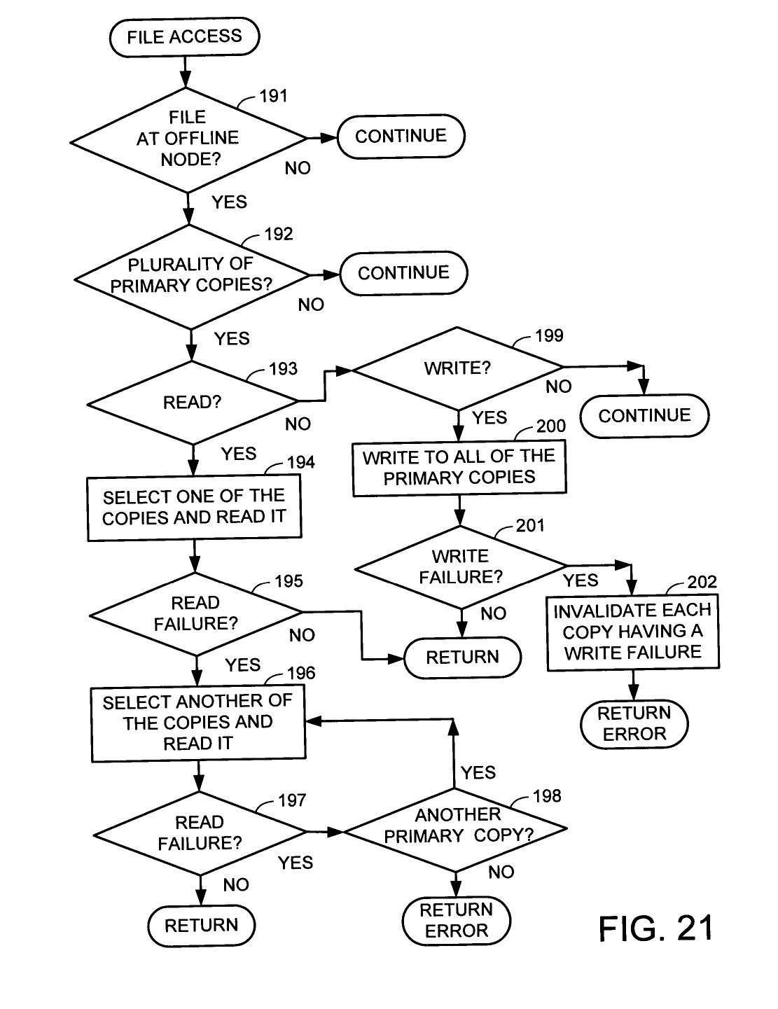

FIG. 21 shows a specific procedure for file access to primary copies of a file. In step 191, if the file access is to a file at an offline inode of the namespace tree, then execution continues to step 191. For example, an inode number is decoded from the file handle, and used to access the corresponding offline inode in the namespace tree, and the offline inode in the namespace tree has an attribute indicating its object type. In step 192, if the inode has entries for a plurality of primary copies, then execution continues to step 193. In step 193, for read access, execution continues to step 194. In step 194, the namespace server selects one of the primary copies and sends a read request to the file server specified in the backend NAS network pathname for the selected primary copy. In step 195, if a successful reply is received from the file server, then execution returns. Otherwise, if the reply from the file server indicates a read failure, then execution continues to step 196. In step 196, the namespace server selects another of the primary copies and reads it by sending a read request to the file server specified in the backend NAS network pathname for this primary copy. In step 197, if the read operation is successful, then execution returns. If there is a read failure, then execution continues to step 198. In step 198, if there are not more primary copies that can be read, then execution returns with an error. If there are more primary copies that can be read, then execution continues to step 196 to select another primary copy that can be read.

In step 193, if the file access request is not a read request, then execution continues to step 199. In step 199, if the file access request is a write request, then execution continues to step 200 to write to all of the primary copies by sending write requests to all of the file servers containing the primary copies, as indicated by the backend NAS network pathnames for the primary copies. In step 201, if all servers reply that the write operations were successful, then execution returns. If there was a write failure, execution continues to step 202. In step 202, the namespace server invalidates each copy having a write failure, for example by marking as invalid each entry in the offline inode for each invalid primary copy.

If the namespace server finds that there are no primary copies of a file to be accessed or if the primary copies are found to be inaccessible, then the namespace server may access a secondary copy. If a primary copy is found to be inaccessible, this fact is reported to the policy engine, and the policy engine may choose to select a file server for creating a new primary copy and initiate a migration process to create a primary copy from a secondary copy.

If the namespace server finds that there are no accessible primary or secondary copies of a file to be accessed, then the namespace server reports this fact to the policy engine. The policy engine may choose to initiate a recovery operation that may involve accessing the point-in-time versions, starting with the most recent point-in-time version, and re-doing transactions upon the point-in-time version. If the recovery operation is successful, an entry will be put into the offline inode pointing to the location of the recovered file in primary storage, and then the namespace server will access the recovered file.

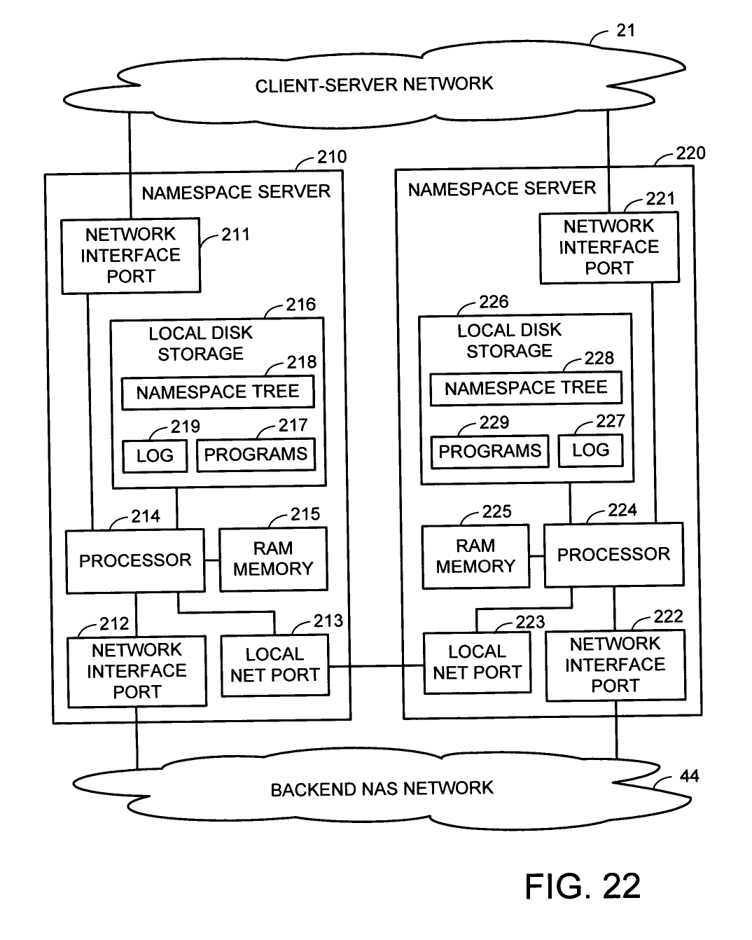

FIG. 22 shows a dual-redundant cluster of two namespace servers 210 and 220 that are linked together so that the namespace tree in each of the namespace servers will contain the same configuration of virtual and offline inodes. The namespace server 210 has a client-server network interface port 211, a backend NAS network interface port 212, a local network interface port 213, a processor 214, a random-access memory 215, and local disk storage 216. The local disk storage 216 contains programs 217 executable by the processor 214, at least the virtual and offline nodes of the namespace tree 218, and a log file 219. In a similar fashion, the namespace server 220 has a client-server network interface port 221, a backend NAS network interface port 222, a local network interface port 223, a processor 224, a random-access memory 225, and local disk storage 226. The local disk storage 226 contains programs 227 executable by the processor 224, at least the virtual and offline nodes of a namespace tree 228, and a log file 219.

The configured portion of the namespace tree 218 from the local disk storage 216 is cached in the memory 215 together with cached inodes of the namespace tree for any outstanding file handles or fids. When the namespace tree needs to be reconfigured, the processor 214 obtains write locks on the inodes of the namespace tree that need to be modified. The write locks include local write locks on the inodes of the namespace tree 218 in the namespace server 210 and also remote write locks on the inodes of the namespace tree 228 in the other namespace server 220. If the inodes to be write locked are also cached in the memories 215, 225, these cached inode copies are invalidated. Then changes are first written to the logs 219, 229 and then written to the write-locked inodes of namespace trees 218, 228 in the local disk storage 216, 226 in each of the namespace servers 210, 220. In this fashion, the two namespace servers 210, 220 are clustered together for bi-directional synchronous mirroring of the configured inodes in the namespace trees.

If one of the namespace servers should crash, it could be re-booted and the namespace configuration information could either be recovered from the other namespace server or recovered from its local log. Also, each of the namespace servers could monitor the health of the other, and if one of the namespace servers would not recover upon reboot from a crash, the other namespace server could service the clients that would otherwise be serviced by the failed namespace server. Monitoring and fail-over of service from one of the namespace servers to the other could also use methods described in Duso et al. U.S. Pat. No. 6,625,750 issued Sep. 23, 2003, incorporated herein by reference.

In view of the above, there has been described a namespace server that can receive client requests for access to files referenced by pathnames in a client-server namespace, and can translate the requests from the client into translated requests sent from the network namespace server to a file server for access to files referenced by pathnames in a backend NAS network namespace. Therefore it is possible to scale the namespace capacity seamlessly, by abstracting the namespace management and representation from the actual data storage locations. The namespace server also has the capability of changing the translation of a client-server network pathname from an old backend NAS network pathname to a new backend NAS network pathname during concurrent client read-write access. This allows for transparent data re-distribution for balancing storage utilization, performance balancing, and resource management. It also allows for transparent data duplication for data availability and protection. Client access can also be routed automatically and transparently to replicas in case of server or site failures. End users are protected from disruption due to changes in data location, protection, or service level. The namespace server can perform a translation between different file access protocols, so that a NFS client can access files serviced by a CIFS file server, and a CIFS client can access files serviced by a NFS file server. The namespace server can create the appearance of a virtual file system that contains multiple physical file servers, virtual shares that contain multiple physical shares from different file servers, virtual directories that contain files on different file servers, and files that contain data from files on different file servers. The client-server network can have the same or a similar namespace while servers are added to increase the storage capacity of the virtual file systems, virtual shares, and virtual files. The storage capacity of the virtual objects can exceed the capacity limitations of the corresponding physical objects. The virtual objects can be assigned to particular user groups.

What is claimed is:

1. A namespace server comprising:
memory for storing translation information for translating client requests for access to files referenced by pathnames in a client-server network namespace into requests for access to files referenced by pathnames in a NAS network namespace, and
at least one processor coupled to the memory for accessing the translation information, said at least one processor being programmed for translating the client requests for access to the files referenced by pathnames in the client-server network namespace into the requests for access to the files referenced by the pathnames in the NAS network namespace, said at least one processor also being programmed for changing the translation of a client-server network pathname for a file from an old NAS network pathname for the file to a new NAS network pathname for the file for migrating the file without disruption to concurrent client read-write access to the file.

2. The namespace server as claimed in claim 1, further comprising a client-server network port for connecting the namespace server into the client-server network, and a backend NAS network port for connecting the namespace server into a backend NAS network in the NAS network namespace, said at least one processor being programmed so that the namespace server functions as a gateway between the client-server network to the backend NAS network for client file access requests received by the namespace server from the client-server network and translated by the namespace server to produce translated file access requests sent to at least one file server in the backend NAS network.

3. The namespace server as claimed in claim 1, wherein said at least one processor is programmed for receiving from a client the client requests for access to files referenced by pathnames in the client-server network namespace in accordance with the Network File System (NFS) protocol, and said at least one processor is programmed for transmitting to a file server the requests for access to files referenced by pathnames in a NAS network namespace in accordance with the Common Internet File System (CIFS) protocol.

4. The namespace server as claimed in claim 1, wherein said at least one processor is programmed for receiving from a client the client requests for access to files referenced by pathnames in the client-server network namespace in accordance with the Common Internet File System (CIFS) protocol, and said at least one processor is programmed for transmitting to a file server the requests for access to files referenced by pathnames in a NAS network namespace in accordance with the Network File System (NFS) protocol.

5. The namespace server as claimed in claim 1, wherein the memory contains a namespace tree defining a translation of the client-server network namespace into the NAS network namespace, the namespace tree including inodes for names in the client-server network namespace for shares, directories, and files.

6. The namespace server as claimed in claim 1, wherein the memory and said at least one processor are programmed to create the appearance of a virtual file system in the client-server namespace, wherein the virtual file system contains physical shares from different physical file servers in the NAS network namespace.

7. The namespace server as claimed in claim 1, wherein the memory and said at least one processor are programmed to create the appearance of a virtual directory in the client-server namespace, wherein the virtual directory contains files from different physical file servers in the NAS network namespace.

8. The namespace server as claimed in claim 1, wherein the memory and said at least one processor are programmed to create the appearance of a virtual file in the client-server namespace, wherein the virtual file contains data from files in different physical file servers in the NAS network namespace.

9. A namespace server comprising:
memory for storing translation information for translating client requests for access to files referenced by pathnames in a client-server network namespace into requests for access to files referenced by pathnames in a NAS network namespace, and
at least one processor coupled to the memory for accessing the translation information, said at least one processor being programmed for translating the client requests for access to the files referenced by pathnames in the client-server network namespace into the requests for access to the files referenced by the pathnames in the NAS network namespace,
wherein said at least one processor is programmed for receiving from a client the client requests for access to files referenced by pathnames in the client-server network namespace in accordance with a first high-level file access protocol, and said at least one processor is programmed for transmitting to a file server the requests for access to files referenced by pathnames in a NAS network namespace in accordance with a second high-level file access protocol, and
wherein one of the first and second high level file access protocols is the Network File System (NFS) protocol, and the other of the first and second file access protocols is the Common Internet File System (CIFS) protocol.

10. The namespace server as claimed in claim 9, wherein said at least one processor is programmed for receiving from a client the client requests for access to files referenced by pathnames in the client-server network namespace in accordance with the Network File System (NFS) protocol, and said at least one processor is programmed for transmitting to a file server the requests for access to files referenced by pathnames in a NAS network namespace in accordance with the Common Internet File System (CIFS) protocol.

11. The namespace server as claimed in claim 9, wherein said at least one processor is programmed for receiving from a client the client requests for access to files referenced by pathnames in the client-server network namespace in accordance with the Common Internet File System (CIFS) protocol, and said at least one processor is programmed for transmitting to a file server the requests for access to files referenced by pathnames in a NAS network namespace in accordance with the Network File System (NFS) protocol.

12. The namespace server as claimed in claim 9, further comprising a client-server network port for connecting the namespace server into the client-server network, and a backend NAS network port for connecting the namespace server into a backend NAS network in the NAS network namespace, said at least one processor being programmed so that the namespace server functions as a gateway between the client-server network to the backend NAS network for client file access requests received by the namespace server from the client-server network and translated by the namespace server to produce translated file access requests sent to at least one file server in the backend NAS network.

13. The namespace server as claimed in claim 9, wherein the memory contains a namespace tree defining a translation of the client-server network namespace into the NAS network namespace, the namespace tree including inodes for names in the client-server network namespace for shares, directories, and files.

14. A namespace server comprising:
memory for storing translation information for translating client requests for access to files referenced by pathnames in a client-server network namespace into requests for access to files referenced by pathnames in a NAS network namespace, and
at least one processor coupled to the memory for accessing the translation information, said at least one processor being programmed for translating the client requests for access to the files referenced by pathnames in the client-server network namespace into the requests for access to the files referenced by the pathnames in the NAS network namespace,
wherein the memory contains a namespace tree defining a translation of the client-server network namespace into the NAS network namespace, the namespace tree including inodes for names in the client-server network namespace for shares, directories, and files.

15. The namespace server as claimed in claim 14, wherein said at least one processor is programmed to dynamically extend the namespace tree by instantiating an inode for a specified file when performing a namespace lookup for the specified file to produce a file identifier for the specified file, the file identifier identifying the inode for the specified file.

16. The namespace server as claimed in claim 14, wherein the memory contains a NAS network pathname of a directory in a file server, the NAS network pathname of the directory in the file server being associated with an inode of the namespace tree, the directory having a file, and said at least one processor is programmed to search for the file given a client-server network pathname for the file by searching down the namespace tree and finding the NAS network pathname of the directory, and upon finding the NAS network pathname of the directory, sending a file name lookup request to the file server for searching for the file beginning at the directory.

17. The namespace server as claimed in claim 14, wherein the namespace server tree has an inode for the name of a file in the client-server network namespace, and said at least one processor is programmed for responding to a request from a client to delete the file by sending a request to delete the file to a file server containing the file, and upon receiving confirmation from the file server that the file has been deleted, updating the namespace tree to remove the name for the file from the client-server namespace.

18. The namespace server as claimed in claim 14, wherein the memory contains a plurality of NAS network pathnames associated with copies of a file, the plurality of NAS network pathnames being associated with an inode of the namespace tree, and wherein said at least one processor is programmed to respond to a request for read access to the file by attempting to access one of the copies of the file having one of the plurality of NAS network pathnames, and upon failing to access said one of the copies of the file having said one of the plurality of NAS network pathnames, attempting to access another of the copies of the file having another of the plurality of NAS network pathnames.

19. The namespace server as claimed in claim 14, wherein the memory contains a plurality of NAS network pathnames associated with copies of a file, the plurality of NAS network pathnames being associated with an inode of the namespace tree, and wherein said at least one processor is programmed to respond to a request for write access to the file by attempting to write to each of the plurality of copies of the file, and upon failing to write to one of the plurality of copies of the file, invalidating said one of the plurality of copies of the file.

20. The namespace server as claimed in claim 14, wherein the memory contains a plurality of NAS network pathnames associated with point-in-time copies of a file, and the plurality of NAS network pathnames are associated with an inode of the namespace tree.
